(19) United States
(12) Patent Application Publication
(10) Pub. No.: US 2026/0006472 A1
(43) Pub. Date: Jan. 1, 2026

(54) METHOD AND APPARATUS FOR TRANSMITTING MEASUREMENT CONFIGURATION INFORMATION, AND READABLE STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/880,655

(22) PCT Filed: Jul. 6, 2022
(86) PCT No.: PCT/CN2022/104243

§ 371 Date: Jan. 2, 2025

(51) Int. Cl. H04W 24/10; H04B 17/318; H04W 72/231

(52) U.S. Cl. CPC H04W 24/10; H04B 17/328; H04W 72/231

(57) ABSTRACT

A method, non-transitory computer-readable media, and system for managing measurement configuration in wireless communication is disclosed. The method, performed by user equipment, includes receiving measurement configuration information from a network device that specifies measurement gap configurations for a serving cell and optionally for candidate cells. The user equipment performs power measurements on reference signals for candidate cells based on these configurations, enabling optimized signal assessment during defined measurement gaps. The method also incorporates threshold-based triggering for measurements and reporting, activation or deactivation of measurement gaps via control signaling, and timing measurements between serving and candidate cells to refine configuration. The methods, apparatuses and non-transitory computer-readable media, enhance efficiency in network handovers and power management in wireless communication systems.

### CROSS-REFERENCE TO RELATED APPLICATION

The present application is a U.S. National Stage of International Application No. PCT/CN2022/104243, filed on Jul. 6, 2022, the contents of which are incorporated herein by reference in their entirety.

### TECHNICAL FIELD

The present disclosure relates to the field of wireless communication technology and, in particular, to methods and apparatuses for transmitting measurement configuration information, and readable storage media.

### BACKGROUND

In the 5G new radio communication system, the signal quality of the current serving cell (active PCell or PSCell) and candidate serving cell is currently determined based on the results of layer 3 (L3) measurements. In this process, the switching delay is long, especially in a frequency range 2 (FR2) scenarios where cell coverage is relatively small, and the long switching delay will affect the throughput and mobility performance of the serving cell. Therefore, the problem of long delay during cell switching needs to be solved.

### SUMMARY

The present disclosure provides methods and apparatuses for transmitting measurement configuration information, and readable storage media.

In a first aspect, the present disclosure provides a method of receiving measurement configuration information, performed by a user equipment and including: receiving first measurement configuration information sent by a network device, where the first measurement configuration information at least indicates measurement gap configuration information for a serving cell; and performing a power measurement on a reference signal for a candidate cell according to the measurement gap configuration information for the serving cell.

In the method of the present disclosure, the user equipment can determine the measurement gap configuration information for the serving cell according to the first measurement configuration information configured by the network device, and perform the power measurement on the reference signal for the candidate cell according to the measurement gap configuration information for the serving cell. Therefore, in the present disclosure, the user equipment can realize effective neighbor cell measurement through the measurement gap configuration configured by the network device.

In some possible implementations, the first measurement configuration information further indicates measurement gap configuration information for at least one candidate cell.

In some possible implementations, the power measurement on the reference signal is a power measurement on a layer 1 reference signal.

In some possible implementations, the first measurement configuration information indicates a plurality of sets of measurement gap configuration information, where the plurality of sets of measurement gap configuration information correspond to a plurality of cells respectively, and the plurality of cells at least include the serving cell and at least one candidate cell.

In some possible implementations, the measurement gap configuration information indicates a measurement gap, and wherein, during the measurement gap, the user equipment performs the power measurement on the reference signal for the candidate cell without performing service transmission with the serving cell.

In some possible implementations, the performing a power measurement on a reference signal for a candidate cell according to the measurement gap configuration information for the serving cell includes: measuring, in response to layer 1 reference signal receiving power of the serving cell being lower than a first threshold value, layer 1 reference signal receiving power of the candidate cell according to the measurement gap configuration information for the serving cell.

In some possible implementations, the method further includes: receiving a radio resource control signaling from the network device, where the radio resource control signaling includes the first threshold value.

In some possible implementations, the method further includes: sending, in response to layer 1 reference signal receiving power of at least one candidate cell not being lower than a second threshold value, the layer 1 reference signal receiving power of the at least one candidate cell to the network device.

In some possible implementations, the method further includes: receiving a control signaling sent by the network device, where the control signaling includes a measurement gap identification and indication information of activating or deactivating the measurement gap configuration information.

In some possible implementations, the performing a power measurement on a reference signal for a candidate cell according to the measurement gap configuration information for the serving cell includes: performing, in response to the control signaling indicating activation of the measurement gap configuration information for the serving cell, a power measurement on a layer 1 reference signal for the candidate cell according to the measurement gap configuration information for the serving cell.

In some possible implementations, the control signaling is a media access control (MAC) signaling or includes downlink control information (DCI).

In some possible implementations, the method further includes: measuring, according to received second measurement configuration information, a system frame number and frame boundary timing difference (SFTD) between the serving cell and at least one candidate cell; and sending an SFTD measurement report to the network device, where the SFTD measurement report includes the SFTD between the serving cell and at least one candidate cell, and the first measurement configuration information is determined by the network device according to the SFTD measurement report.

In some possible implementations, the second measurement configuration information includes: indication information that the user equipment is required to perform an SFTD measurement, and indication information of at least one candidate cell to be performed the SFTD measurement.

In some possible implementations, the measurement gap configuration information includes at least one of: a measurement gap identification; a measurement gap duration; a measurement gap repetition period; or a measurement gap initial offset value.

In a second aspect, the present disclosure provides a method of sending measurement configuration information, performed by a network device and including: sending first measurement configuration information to a user equipment, where the first measurement configuration information at least indicates measurement gap configuration information for a serving cell, and the measurement gap configuration information indicates measurement gap information configured for the user equipment to perform a power measurement on a reference signal for a candidate cell, and the measurement gap information is for the serving cell.

In the methods of the present disclosure, the network device indicates measurement gap configuration information for the serving cell by sending the first measurement configuration information to the user equipment. The user equipment can determine the measurement gap configuration information for the serving cell, and perform the power measurement on the reference signal for the candidate cell according to the measurement gap configuration information for the serving cell. Therefore, the network device can configure the user equipment with reasonable measurement gap configuration information, so that the user equipment can realize effective neighbor cell measurement.

In some possible implementations, the method further includes: receiving layer 1 reference signal receiving power of at least one candidate cell sent by the user equipment, where the layer 1 reference signal receiving power of the at least one candidate cell is not lower than a second threshold value; and switching the user equipment from accessing the serving cell to accessing a target candidate cell among the at least one candidate cell.

In some possible implementations, the method further includes: sending a control signaling to the user equipment, where the control signaling includes a measurement gap identification and indication information of activating or deactivating the measurement gap configuration information.

In some possible implementations, the method further includes: sending second measurement configuration information to the user equipment; and receiving a system frame number and frame boundary timing difference (SFTD) measurement report sent by the user equipment, where the SFTD measurement report includes an SFTD between the serving cell and at least one candidate cell.

In some possible implementations, the second measurement configuration information includes: indication information that the user equipment is required to perform an SFTD measurement, and indication information of at least one candidate cell to be performed the SFTD measurement.

In some possible implementations, the method further includes: determining the measurement gap configuration information for the serving cell according to the SFTD between the serving cell and at least one candidate cell.

In a third aspect, the present disclosure provides an apparatus for receiving measurement configuration information, which can be configured to perform the steps performed by the user equipment in the first aspect or any possible design of the first aspect. The user equipment can realize the functions in the above methods through a hardware structure, a software module, or a hardware structure plus a software module.

When implementing the apparatus shown in the third aspect through software modules, the apparatus may include a transceiving module and a processing module coupled with each other, where the transceiving module can be configured to support communication of the communication apparatus, and the processing module can be configured for the communication apparatus to perform processing operations, such as generating to-be-sent information/messages or processing received signals to obtain information/messages.

When performing the steps described in the first aspect, the transceiver module is configured to receive first measurement configuration information sent by a network device, where the first measurement configuration information at least indicates measurement gap configuration information for a serving cell. The processing module is configured to perform a power measurement on a reference signal for a candidate cell according to the measurement gap configuration information for the serving cell.

In a fourth aspect, the present disclosure provides an apparatus for sending measurement configuration information, which can be configured to perform the steps performed by the network device in the second aspect or any possible design of the second aspect. The network device can realize the functions in the above methods through a hardware structure, a software module, or a hardware structure plus a software module.

When the apparatus shown in the fourth aspect is realized by a software module, the apparatus may include a transceiving module, where the transceiving module may be configured to support the communication apparatus for communication.

When performing the steps in the second aspect, the transceiving module is configured to send first measurement configuration information to a user equipment, where the first measurement configuration information at least indicates measurement gap configuration information for a serving cell, and the measurement gap configuration information indicates measurement gap information configured for the user equipment to perform a power measurement on a layer 1 reference signal for a candidate cell, and the measurement gap information is for the serving cell.

In a fifth aspect, the present disclosure provides a communication apparatus, including a processor and a memory, the memory is configured to store a computer program, and the processor is configured to execute the computer program to realize the first aspect or any possible design of the first aspect.

In a sixth aspect, the present disclosure provides a communication apparatus, including a processor and a memory, the memory is configured to store a computer program, and the processor is configured to execute the computer program to realize the second aspect or any possible design of the second aspect.

In a seventh aspect, the present disclosure provides a computer-readable storage medium, in which instructions (or named as computer programs, programs) are stored, which, when called for execution on a computer, cause the computer to execute the first aspect or any possible design of the first aspect.

In an eighth aspect, the present disclosure provides a computer-readable storage medium, in which instructions (or named as computer programs, programs) are stored, which, when called for execution on a computer, cause the computer to execute the second aspect or any possible design of the second aspect.

It should be understood that the above general description and the following detailed descriptions are examples and explanatory only and do not limit the present disclosure.

### BRIEF DESCRIPTION OF DRAWINGS

The accompanying drawings described herein are provided to provide a further understanding of embodiments of the present disclosure and constitute a part of the present disclosure. Illustrative embodiments of the embodiments of the present disclosure and their descriptions are used to explain the embodiments of the present disclosure and do not constitute improper limitations on the embodiments of the present disclosure.

The accompanying drawings, which are incorporated in and constitute a part of the specification, illustrate embodiments consistent with the embodiments of the present disclosure, and are used together with the specification to explain the principles the embodiments of the present disclosure.

FIG. 1 is a schematic architectural diagram of a wireless communication system according to an embodiment of the present disclosure.

FIG. 2 is a flowchart of a method of transmitting measurement configuration information according to an embodiment of the present disclosure.

FIG. 3 is a flowchart of another method of transmitting measurement configuration information according to an embodiment of the present disclosure.

FIG. 4 is a flowchart of a method of receiving measurement configuration information according to an embodiment of the present disclosure.

FIG. 5 is a flowchart of another method of receiving measurement configuration information according to an embodiment of the present disclosure.

FIG. 6 is a flowchart of another method of receiving measurement configuration information according to an embodiment of the present disclosure.

FIG. 7 is a flowchart of another method of receiving measurement configuration information according to an embodiment of the present disclosure.

FIG. 8 is a flowchart of another method of receiving measurement configuration information according to an embodiment of the present disclosure.

FIG. 9 is a flowchart of a method of sending measurement configuration information according to an embodiment of the present disclosure.

FIG. 10 is a flowchart of another method of sending measurement configuration information according to an embodiment of the present disclosure.

FIG. 11 is a flowchart of another method of sending measurement configuration information according to an embodiment of the present disclosure.

FIG. 12 is a schematic diagram of a communication scenario according to an embodiment of the present disclosure.

FIG. 13 is a block diagram of an apparatus for receiving measurement configuration information according to an embodiment of the present disclosure.

FIG. 14 is a block diagram of user equipment according to an embodiment of the present disclosure.

FIG. 15 is a block diagram of an apparatus for transmitting measurement configuration information according to an embodiment of the present disclosure.

FIG. 16 is a block diagram of a communication apparatus according to an embodiment of the present disclosure.

### DETAILED DESCRIPTION

Embodiments of the present disclosure are further described in connection with the accompanying drawings and specific embodiments.

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of the present disclosure as detailed in the appended claims.

Terms used in embodiments of the present disclosure are only for the purpose of describing specific embodiments and are not limiting the embodiments of the present disclosure. Singular forms of “a,” said,” and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “in a case that” and “if” as used herein can be interpreted as “at” or “when” or “in response to determining”.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are examples and are intended to explain the present disclosure, and should not be construed as limiting the present disclosure.

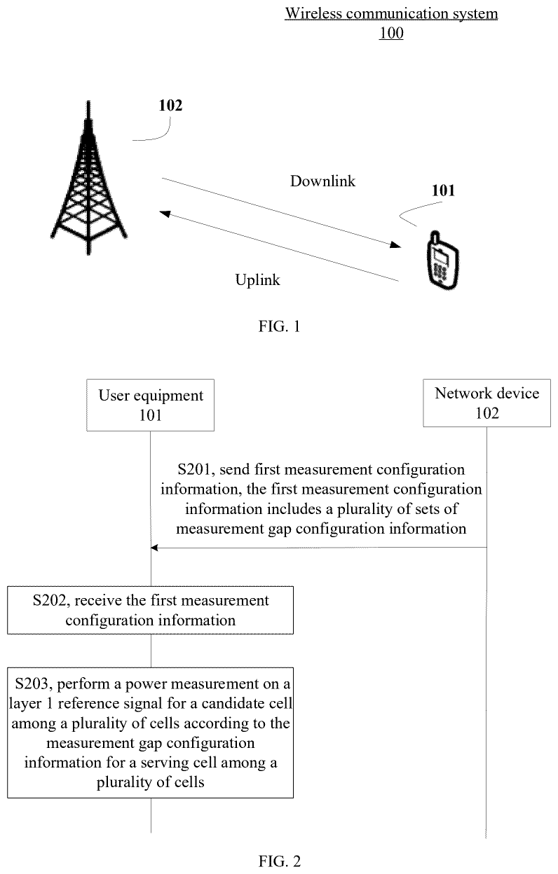

As shown in FIG. 1, a method of transmitting measurement configuration information provided by an embodiment of the present disclosure may be applied to a wireless communication system 100, which may include a user equipment 101 and a network device 102. The user equipment 101 is configured to support carrier aggregation and can be connected to a plurality of carrier units of the network device 102, including a primary carrier unit and one or more secondary carrier units.

It should be understood that the above wireless communication system 100 can be applied to both low-frequency and high-frequency scenarios. Application scenarios of the wireless communication system 100 include, but are not limited to, a long term evolution (LTE) system, a frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The user equipment 101 shown above may be a terminal, an access terminal, a terminal unit, a terminal station, a mobile station (MS), a distant station, a remote terminal, a mobile terminal, a wireless communication device, a terminal agent, or a terminal device, etc. The user equipment 101 may have a wireless transceiving function, and it can communicate with one or more network devices of one or more communication systems (such as wireless communication) and accept network services provided by the network devices, and the network device here includes but not limited to the network device 102 shown in the figure.

The user equipment (UE) 101 may be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle mounted device, a wearable device, a terminal device in future 5G networks, or a terminal device in future evolved PLMN networks, etc.

The network device 102 may be an access network device (or an access network point). The access network device refers to a device that provides network access functions, such as a radio access network (RAN) base station and so on. The network device 103 may specifically include a base station (BS), or include a base station and a radio resource management device for controlling the base station. The network device 102 may further include a relay station (relay device), an access point, and a base station in future 5G networks, a base station in future evolved PLMN networks or an NR base station. The network device 102 may be a wearable device or a vehicle-mounted device. The network device 102 may also be a communication chip with a communication module.

For example, the network device 102 may include, but is not limited to, a next-generation base station (gnodeB, gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (e.g., home evolved nodeB, or home node B, HNB), a baseband unit (BBU), a transmission and receiving point (TRP), a transmitting point (TP), or a mobile switching center.

During a cell switching (handover) based on layer 1 (L1) or layer 2 (L2) measurement, a switching delay is less than a cell switching based on L3 measurement. During the cell switching process for L1/L2 measurement, the network device 102 simultaneously configures configuration information of the current serving cell and the candidate serving cell for the user equipment 101. When the to-be-measured cell includes inter-frequency cells, it is also necessary to solve the configuration and scheduling problem of measurement gap for L1/L2 parameter measurement.

The present disclosure provides a method for transmitting measurement configuration information, referring to FIG. 2, which is a method of transmitting measurement configuration information according to an embodiment of the present disclosure. As shown in FIG. 2, the method includes steps S201˜S203, specifically:
at step S201, a network device 102 sends first measurement configuration information to a user equipment 101, where the first measurement configuration information includes a plurality of sets of measurement gap configuration information, and the plurality of sets of measurement gap configuration information correspond to a plurality of cells respectively, where the measurement gap configuration information indicates measurement gap information configured for the user equipment to perform a power measurement on a layer 1 reference signal for a candidate cell among the plurality of cells, and the measurement gap information is for a serving cell.

Of course, the network device 102 may only send the measurement gap configuration information for the serving cell. Accordingly, the user equipment 101 measures layer 1 reference signal power of one or more candidate cells according to the measurement gap configuration information for the serving cell.

At step S202, the user equipment 101 receives the first measurement configuration information sent by the network device 102, the first measurement configuration information includes the plurality of sets of measurement gap configuration information, and the plurality of sets of measurement gap configuration information correspond to the plurality of cells.

At step S203, the user equipment 101 performs the power measurement on the layer 1 reference signal for the candidate cell among the plurality of cells according to the measurement gap configuration information for the serving cell among the plurality of cells.

In an embodiment of the present disclosure, the user equipment 101 corresponds to a plurality of cells, the plurality of cells including: a serving cell currently accessed by the user equipment 101 and at least one candidate serving cell (candidate serving cell(s)). The serving cell can be a primary serving cell (active cell, or named as source active PCell) or a primary secondary serving cell (active PSCell, or named as Source active PSCell). The plurality of cells refers to two or more cells. In other embodiments of the present disclosure, the definition of the plurality of cells may be the same as this embodiment, and will not be repeated here.

In some possible implementations, each cell corresponds to a set of measurement gap configuration information. When the user equipment 101 accesses a cell, that is, the cell is a serving cell, the user equipment 101 can measure the power of layer 1 reference signal (or L1 reference signal receiving power, L1-RSRP) of a candidate cell according to the measurement gap configuration information for the serving cell, so as to perform cell switching in combination with the signal quality of the serving cell and the candidate cell.

In some possible implementations, when the user equipment 101 is switched from accessing the serving cell to accessing a target candidate cell, the target candidate cell becomes a new serving cell. The user equipment 101 performs a L1-RSRP measurement for a new candidate cell based on the first measurement configuration information for the target candidate cell.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 indicates the corresponding measurement gap configuration information for each cell by sending the first measurement configuration information to the user equipment 101. The user equipment 101 can determine the measurement gap configuration information for the serving cell, and perform the power measurement on the layer 1 reference signal for the candidate cell according to the measurement gap configuration information for the serving cell. Therefore, the network device 102 can configure the user equipment 101 with reasonable measurement gap configuration information, so that the user equipment 101 can realize effective neighbor cell measurement through the measurement gap configuration of the network device, and the user equipment 101 can reduce the switching delay and improve the mobility performance through the measurement gap configuration information.

Or, the method of the present disclosure includes steps S201′ to S203′, specifically:
at step S201′, the network device 102 sends first measurement configuration information to the user equipment 101, where the first measurement configuration information at least indicates measurement gap configuration information for a serving cell, and the measurement gap configuration information indicates measurement gap information configured for the user equipment to perform a power measurement on a reference signal for a candidate cell, and the measurement gap information is for the serving cell.

At step S202′, the user equipment 101 receives the first measurement configuration information sent by the network device 102, where the first measurement configuration information at least indicates the measurement gap configuration information for the serving cell.

At step S203′, the user equipment 101 performs the power measurement on the reference signal for the candidate cell according to the measurement gap configuration information for the serving cell.

In some possible implementations, the first measurement configuration information further indicates measurement gap configuration information for at least one candidate cell.

In some possible implementations, the power measurement on the reference signal is a power measurement on a layer 1 reference signal.

In the embodiment of the present disclosure, the user equipment 101 can determine the measurement gap configuration information for the serving cell according to the first measurement configuration information configured by the network device 102, and perform the power measurement on the reference signal for the candidate cell according to the measurement gap configuration information for the serving cell. Therefore, in the present disclosure, the user equipment can realize effective neighbor cell measurement through the measurement gap configuration configured by the network device.

Or, the method of the present disclosure includes steps S201″ to S203″, specifically:
at step S201″, the network device 102 sends first measurement configuration information to the user equipment 101, where the first measurement configuration information at least indicates measurement gap configuration information for a serving cell, and the measurement gap configuration information indicates measurement gap information configured for the user equipment to perform a power measurement on a layer 1 reference signal for a candidate cell, and the measurement gap information is for the serving cell.

At step S202″, the user equipment 101 receives the first measurement configuration information sent by the network device 102, where the first measurement configuration information at least indicates measurement gap configuration information for the serving cell.

At step S203″, the user equipment 101 performs the power measurement on the layer 1 reference signal for the candidate cell according to the measurement gap configuration information for the serving cell.

In the embodiment of the present disclosure, the user equipment 101 can determine the measurement gap configuration information for the serving cell according to the first measurement configuration information configured by the network device 102, and perform the power measurement on the layer 1 reference signal for the candidate cell according to the measurement gap configuration information for the serving cell. Therefore, in the present disclosure, the user equipment 101 can not only realize effective neighbor cell measurement through the measurement gap configuration configured by the network device 102, but also measure a layer 1 parameter in combination with the measurement gap configuration information to reduce the switching delay and improve the mobility performance.

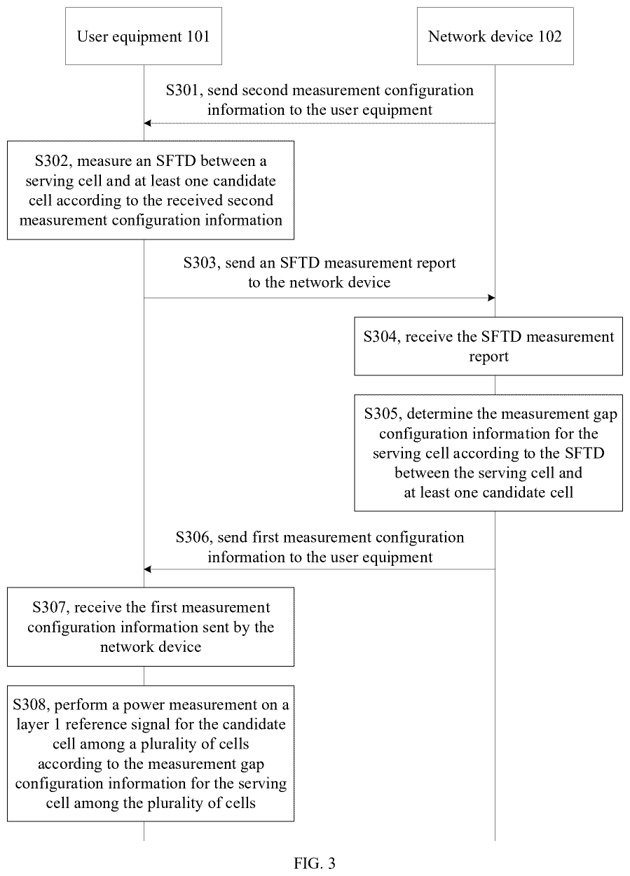

The present disclosure provides a method for transmitting measurement configuration information, referring to FIG. 3, which is a method of transmitting measurement configuration information according to an embodiment of the present disclosure. As shown in FIG. 3, the method includes steps S301˜S308, specifically:
at step S301, a network device 102 sends second measurement configuration information to a user equipment 101.

At step S302, the user equipment 101 measures a system frame number and frame boundary timing difference (SFTD) between a serving cell and at least one candidate cell according to the received second measurement configuration information.

At step S303, the user equipment 101 sends an SFTD measurement report to the network

device 102, where the SFTD measurement report indicates the SFTD between the serving cell and at least one candidate cell, and the first measurement configuration information is determined by the network device 102 according to the SFTD measurement report.

At step S304, the network device 102 receives the SFTD measurement report sent by the user equipment 101, where the SFTD measurement report includes the SFTD between the serving cell and at least one candidate cell.

At step S305, the network device 102 determines the measurement gap configuration information for the serving cell according to the SFTD between the serving cell and at least one candidate cell.

At step S306, the network device 102 sends first measurement configuration information to the user equipment 101, where the first measurement configuration information includes a plurality of sets of measurement gap configuration information, and the plurality of sets of measurement gap configuration information correspond to a plurality of cells respectively, where the measurement gap configuration information indicates measurement gap information configured for the user equipment to perform a power measurement on a layer 1 reference signal for a candidate cell among the plurality of cells, and the measurement gap information is for the serving cell. Of course, the network device 102 may only send the measurement gap configuration information for the serving cell. Accordingly, the user equipment 101 measures layer 1 reference signal power of one or more candidate cells according to the measurement gap configuration information for the serving cell.

At step S307, the user equipment 101 receives the first measurement configuration information sent by the network device 102, the first measurement configuration information includes the plurality of sets of measurement gap configuration information, and the plurality of sets of measurement gap configuration information correspond to the plurality of cells. Of course, the network device 102 may only send the measurement gap configuration information for the serving cell. Accordingly, the user equipment 101 measures layer 1 reference signal power of one or more candidate cells according to the measurement gap configuration information for the serving cell.

At step S308, the user equipment 101 performs the power measurement on the layer 1 reference signal for the candidate cell among the plurality of cells according to the measurement gap configuration information for the serving cell among the plurality of cells.

In some possible implementations, the measurement gap configuration information includes at least one of:
a measurement gap identification (ID);
a measurement gap duration (or named as gap duration);
a measurement gap repetition period (or named as gap period); or
a measurement gap initial offset value (or named as gap offset).

In an example, starting from the initial offset value, the user equipment 101 may perform a L1-RSRP measurement for the candidate cell during a duration of a measurement gap. In some implementations, during the duration of the measurement gap, the serving cell does not schedule services for the user equipment 101. That is, during the measurement gap, the user equipment 101 does not communicate with the serving cell and performs the measurement of L1-RSRP for the candidate cell.

In some possible implementations, the network device 102 may send the second measurement configuration information to the user equipment 101 by sending a Radio Resource Control (RRC) message.

In some possible implementations, the second measurement configuration information indicates information for the user equipment 101 to perform an SFTD measurement.

In some possible implementations, the network device 102, in the process of determining the measurement gap configuration information for the serving cell, needs to configure the initial offset value in the measurement gap configuration information based on the SFTD between the serving cell and each candidate cell. In this way, the measurement gap configuration information for each cell is determined respectively, thereby obtaining the first measurement configuration information.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 configures second measurement configuration information for the user equipment 101, and the user equipment 101 performs the SFTD measurement based on the second measurement configuration information and sends the SFTD measurement report to the network device 102. Therefore, the network device 102 can know the SFTD between the serving cell and the candidate cell according to the SFTD measurement report, so as to more accurately configure the measurement gap configuration information for the serving cell.

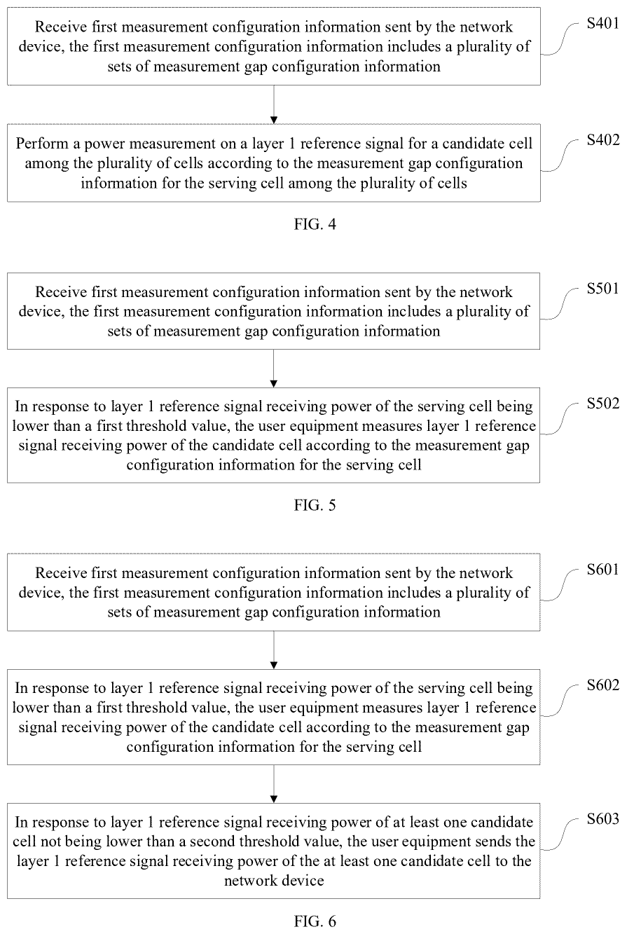

The present disclosure provides a method of receiving measurement configuration information, which is performed by the user equipment 101. Referring to FIG. 4, FIG. 4 is a method of receiving measurement configuration information according to an embodiment of the present disclosure. As shown in FIG. 4, the method includes steps S401˜S402, specifically:
at step S401, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S402, the user equipment 101 performs a power measurement on a layer 1 reference signal for a candidate cell among the plurality of cells according to the measurement gap configuration information for the serving cell among the plurality of cells.

In an embodiment of the present disclosure, the user equipment 101 corresponds to a plurality of cells, the plurality of cells including: a serving cell currently accessed by the user equipment 101 and at least one candidate serving cell (candidate serving cell(s)). The serving cell can be a primary serving cell (Pcell, or named as active cell, or named as source active PCell) or a primary secondary serving cell (PSCell, or named as active PSCell, or named as Source active PSCell). The plurality of cells refers to two or more cells. In other embodiments of the present disclosure, the definition of the plurality of cells may be the same as this embodiment, and will not be repeated here.

In some possible implementations, the measurement gap configuration information includes at least one of:
a measurement gap identification;
a measurement gap duration;
a measurement gap repetition period; or
a measurement gap initial offset value.

In some possible implementations, the network device 102 may send the first measurement configuration information to the user equipment 101 by sending an RRC message.

In some possible implementations, each cell corresponds to a set of measurement gap configuration information.

In an example, measurement gap configuration information for a serving cell (Cell1) is GP #1, measurement gap configuration information for a candidate Cell2 is GP #2, measurement gap configuration information for a candidate Cell3 is GP #3, . . . , and measurement gap configuration information for a candidate cell Celli is GP #i.

In an example, when the serving cell Cell1 is in an active state, the user equipment 101 respectively performs L1-RSRP measurement for one or all of the candidate cells Cell2 to Celli according to GP #1.

In an example, when the candidate cell Cell2 becomes a new serving cell, the user equipment 101 performs L1-RSRP measurements for the new candidate cells Cell1, and Cell 3 to Celli respectively according to the measurement gap configuration information GP #2 for Cell2.

In some possible implementations, after obtaining the L1-RSRP of one or more candidate cells, the user equipment 101 may send a measurement report including the L1-RSRP of the one or more candidate cells to the network device 102.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the user equipment 101 can determine the measurement gap configuration information for the serving cell according to the first measurement configuration information configured by the network device 102, and perform the power measurement on the layer 1 reference signal for the candidate cell according to the measurement gap configuration information for the serving cell. Therefore, in the present disclosure, the user equipment 101 can not only realize effective neighbor cell measurement through the measurement gap configuration configured by the network device 102, but also measure a layer 1 parameter through the measurement gap configuration information to reduce the switching delay and improve the mobility performance.

The present disclosure provides a method of receiving measurement configuration information, which is performed by the user equipment 101. Referring to FIG. 5, FIG. 5 is a method of receiving measurement configuration information according to an embodiment of the present disclosure. As shown in FIG. 5, the method includes steps S501˜S502, specifically:
at step S501, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S502, in response to layer 1 reference signal receiving power of the serving cell being lower than a first threshold value, the user equipment 101 measures layer 1 reference signal receiving power of the candidate cell according to the measurement gap configuration information for the serving cell.

In some possible implementations, the first threshold value (Thres1) is used to indicate whether the user equipment starts L1-RSRP measurement for the candidate cell.

In some possible implementations, the user equipment 101 firstly measures L1-RSRP of the serving cell, and determines whether to start the L1-RSRP measurement of the candidate cell according to a relationship between the L1-RSRP of the serving cell and the first threshold value.

In an example, the L1-RSRP of the serving cell is not lower than the first threshold value, and it is not necessary to measure the L1-RSRP of the candidate cell.

In an example, when the L1-RSRP of the serving cell is lower than the first threshold value, the user equipment 101 performs L1-RSRP measurement of at least one candidate cell in combination with the measurement gap configuration information for the serving cell.

In some possible implementations, the user equipment 101 may report a beam measurement result to the network device 102, and the result includes L1-RSRP of the serving cell and L1-RSRP of each candidate cell. The network device 102 can know the signal quality of the serving cell and the candidate cell according to the result reported by the user equipment 101, so as to perform cell switching based on the signal quality.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 indicates the first threshold value for the user equipment 101, so that the user equipment 101 can dynamically start the L1-RSRP measurement of the candidate cell according to the L1-RSRP of the serving cell and the first threshold value.

The present disclosure provides a method of receiving measurement configuration information, which is performed by the user equipment 101. The method includes steps S501˜S502, specifically:

At step S501, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S501a: the user equipment 101 receives a radio resource control signaling sent by the network device 102, and the radio resource control signaling includes a first threshold value.

At step S502, in response to layer 1 reference signal receiving power of the serving cell being lower than the first threshold value, the user equipment 101 measures layer 1 reference signal receiving power of the candidate cell according to the measurement gap configuration information for the serving cell.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 indicates the first threshold value to the user equipment 101 through an RRC message, so that the user equipment 101 can dynamically start the L1-RSRP measurement of the candidate cell according to the first threshold value indicated by the network device 102.

The present disclosure provides a method of receiving measurement configuration information, which is performed by the user equipment 101. Referring to FIG. 6, FIG. 6 is a method of receiving measurement configuration information according to an embodiment of the present disclosure. As shown in FIG. 6, the method includes steps S601˜S603, specifically:
at step S601, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S602, in response to layer 1 reference signal receiving power of the serving cell being lower than a first threshold value, the user equipment 101 measures layer 1 reference signal receiving power of the candidate cell according to the measurement gap configuration information for the serving cell.

At step S603, in response to layer 1 reference signal receiving power of at least one candidate cell not being lower than a second threshold value, the user equipment 101 sends the layer 1 reference signal receiving power of the at least one candidate cell to the network device 102.

In some possible embodiments, the user equipment 101 compares the obtained L1-RSRP of a plurality of candidate cells with a second threshold value, and does not report L1-RSRPs lower than the second threshold value.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the user equipment 101 screens the to-be-reported L1-RSRP of the candidate cell according to a relationship between the L1-RSRP and the second threshold value, and only reports the L1-RSRP greater than or equal to the second threshold value, which is beneficial to saving the overhead of the side of the network device 102 and improving the efficiency of cell switching.

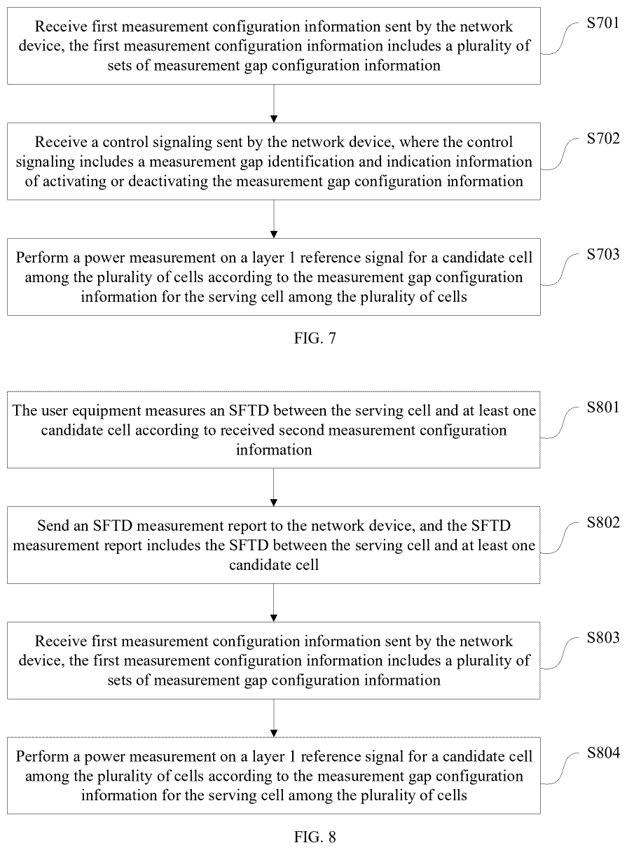

The present disclosure provides a method of receiving measurement configuration information, which is performed by the user equipment 101. Referring to FIG. 7, FIG. 7 is a method of receiving measurement configuration information according to an embodiment of the present disclosure. As shown in FIG. 7, the method includes steps S701˜S703, specifically:

At step S701, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S702, the user equipment 101 receives a control signaling sent by the network device 102, where the control signaling includes a measurement gap identification and indication information of activating or deactivating the measurement gap configuration information.

At step S703, the user equipment 101 performs a power measurement on a layer 1 reference signal for a candidate cell among the plurality of cells according to the measurement gap configuration information for the serving cell among the plurality of cells.

In some possible implementations, the network device 102 indicates to activate or deactivate the measurement gap configuration information for any cell through the sent control signaling.

In an example, network device 102 indicates activating or deactivating the measurement gap configuration information for the serving cell through the control signaling. Correspondingly, when the user equipment 101 determines to activate the measurement gap configuration information for the serving cell, it will correspondingly deactivate the measurement gap configuration information for the candidate cell. The measurement gap configuration information for the service cell may be activated by default, and deactivated by a control command, or the measurement gap configuration information for the serving cell may be deactivated by default and activated by a control command.

In some possible implementations, the control signaling is a media access control (MAC) signaling or includes downlink control information (DCI).

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 reasonably turns off or turns on the required measurement gap configuration information through the sent control signaling, so as to more reasonably perform L1-RSRP measurement of the candidate cell.

The present disclosure provides a method of receiving measurement configuration information, which is performed by the user equipment 101. The method includes steps S701˜S703′, specifically:
At step S701, the user equipment 101 receives first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S702, the user equipment 101 receives a control signaling sent by the network device 102, where the control signaling includes a measurement gap identification and indication information of activating or deactivating the measurement gap configuration information.

At step S703′, in response to the control signaling indicating activation of the measurement gap configuration information for the serving cell, the user equipment 101 performs a power measurement on a layer 1 reference signal for the candidate cell according to the measurement gap configuration information for the serving cell.

In some possible implementations, the control signaling is a media access control (MAC) signaling or includes downlink control information (DCI).

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 dynamically indicates, via the control signaling, that the measurement gap configuration information is turned on or off so that the user equipment 101 can perform the measurement of the candidate cell using reasonable measurement gap configuration information.

The present disclosure provides a method of receiving measurement configuration information, which is performed by the user equipment 101. Referring to FIG. 8, FIG. 8 is a method of receiving measurement configuration information according to an embodiment of the present disclosure. As shown in FIG. 8, the method includes steps S801˜S804, specifically:
at step S801, the user equipment 101 measures an SFTD between the serving cell and at least one candidate cell according to received second measurement configuration information.

At step S802, the user equipment 101 sends an SFTD measurement report to the network device 102, where the SFTD measurement report includes the SFTD between the serving cell and at least one candidate cell, and first measurement configuration information is determined by the network device 102 according to the SFTD measurement report.

At step S803, the user equipment 101 receives the first measurement configuration information sent by the network device 102, the first measurement configuration information includes a plurality of sets of measurement gap configuration information, and the plurality of sets of measurement gap configuration information correspond to a plurality of cells respectively. Of course, the network device 102 may only send the measurement gap configuration information for the serving cell. Accordingly, the user equipment 101 measures layer 1 reference signal power of one or more candidate cells according to the measurement gap configuration information for the serving cell.

At step S804, the user equipment 101 performs a power measurement on a layer 1 reference signal for a candidate cell among the plurality of cells according to the measurement gap configuration information for the serving cell among the plurality of cells.

In some possible implementations, the measurement gap configuration information includes at least one of:
a measurement gap identification;
a measurement gap duration;
a measurement gap repetition period; or
a measurement gap initial offset value.

In some possible implementations, the network device 102, in the process of determining the measurement gap configuration information for the serving cell, needs to configure the initial offset value in the measurement gap configuration information based on the SFTD between the serving cell and each candidate cell. In this way, the measurement gap configuration information for each cell is determined respectively, thereby obtaining the first measurement configuration information.

In some possible implementations, the network device 102 may send second measurement configuration information to the user equipment 101 by sending an RRC message.

In some possible implementations, the control signaling indicates that measurement gap configuration information corresponding to a measurement gap set with an identification is turned on or off.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the user equipment 101 performs the SFTD measurement according to the second measurement configuration information configured by the network device 102, and reports the SFTD measurement report to the network device 102, so that the network device 102 can more accurately and reasonably configure the corresponding measurement gap configuration information.

The present disclosure provides a method of receiving measurement configuration information, which is performed by the user equipment 101. The method includes steps S801˜S804, where the second measurement configuration information includes:

indication information that the user equipment 101 is required to perform an SFTD measurement, and indication information of at least one candidate cell to be performed the SFTD measurement.

In some possible implementations, the second measurement configuration information may further indicate whether the user equipment 101 needs to perform an SFTD measurement. For example, when the second measurement configuration information indicates that the user equipment 101 does not need to perform the SFTD measurement, the user equipment 101 does not need to perform the SFTD measurement. When the second measurement configuration information indicates that the user equipment 101 needs to perform the SFTD measurement, the user equipment 101 will perform the SFTD measurement according to the second measurement configuration information.

In some possible embodiments, the second measurement configuration information may indicate a list of candidate cells to be performed for SFTD measurement, and the user equipment measures an SFTD between each candidate cell in the list and the serving cell, respectively, according to the list of candidate cells.

In some possible implementations, the SFTD measurement report may include the SFTD of the serving cell and each candidate cell.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, combined with the second measurement configuration information configured by the network device 102, the user equipment 101 can know whether the SFTD measurement needs to be performed and the candidate cell corresponding to which the SFTD measurement needs to be performed.

It should be noted that the aforementioned multiple embodiments executed by the user equipment 101 can be executed alone or in any combination, and the embodiment of the present disclosure is not limited to this.

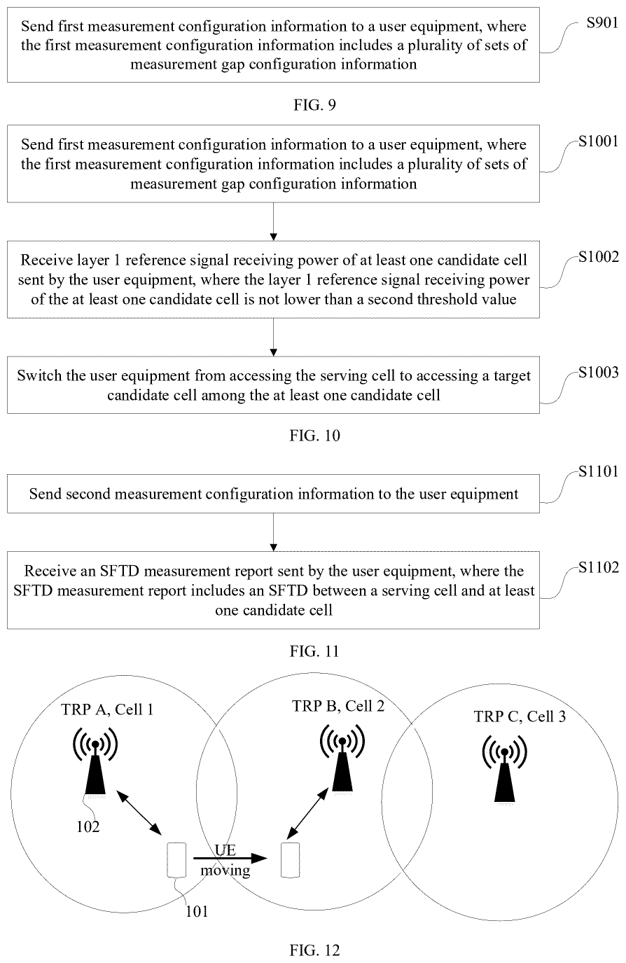

The present disclosure provides a method of sending measurement configuration information, which is performed by the network device 102. Referring to FIG. 9, FIG. 9 is a method of sending configuration information according to an embodiment of the present disclosure. As shown in FIG. 9, the method includes step S901, specifically:
at step S901, the network device 102 sends first measurement configuration information to a user equipment 101, where the first measurement configuration information includes a plurality of sets of measurement gap configuration information, and the plurality of sets of measurement gap configuration information correspond to a plurality of cells respectively, where the measurement gap configuration information includes, in a serving cell among the plurality of cells corresponding to the measurement gap configuration information, measurement gap information that the user equipment 101 performs a power measurement on a layer 1 reference signal for a candidate cell among the plurality of cells. Of course, the network device 102 may only send the measurement gap configuration information for the serving cell. Accordingly, the user equipment 101 measures layer 1 reference signal power of one or more candidate cells according to the measurement gap configuration information for the serving cell.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

Or, the method of the present disclosure includes step S901′:
at step S901′, the network device 102 sends first measurement configuration information to the user equipment 101, where the first measurement configuration information at least indicates measurement gap configuration information for a serving cell, and the measurement gap configuration information indicates measurement gap information configured for the user equipment to perform a power measurement on a reference signal for a candidate cell, and the measurement gap information is for the serving cell.

Or, the method of the present disclosure includes step S901″:
at step S901″, the network device 102 sends first measurement configuration information to the user equipment 101, where the first measurement configuration information at least indicates measurement gap configuration information for a serving cell, and the measurement gap configuration information indicates measurement gap information configured for the user equipment to perform a power measurement on a layer 1 reference signal for a candidate cell, and the measurement gap information is for the serving cell.

In the embodiment of the present disclosure, the network device 102 indicates the corresponding measurement gap configuration information for each cell by sending the first measurement configuration information to the user equipment 101. The user equipment 101 can determine the measurement gap configuration information for the serving cell, and perform the power measurement on the layer 1 reference signal for the candidate cell according to the measurement gap configuration information for the serving cell. Therefore, the network device 102 can configure the user equipment 101 with reasonable measurement gap configuration information, so that the user equipment 101 can realize effective neighbor cell measurement through the measurement gap configuration of the network device 102, and the user equipment 101 can reduce the switching delay and improve the mobility performance through the measurement gap configuration information.

The present disclosure provides a method of sending measurement configuration information, which is performed by the network device 102. Referring to FIG. 10, FIG. 10 is a method of sending configuration information according to an embodiment of the present disclosure. As shown in FIG. 10, the method includes step S1001˜S1003, specifically:

At step S1001, the network device 102 sends first measurement configuration information to a user equipment 101, where the first measurement configuration information includes a plurality of sets of measurement gap configuration information, and the plurality of sets of measurement gap configuration information correspond to a plurality of cells respectively, where the measurement gap configuration information includes, in a serving cell among the plurality of cells corresponding to the measurement gap configuration information, measurement gap information that the user equipment 101 performs a power measurement on a layer 1 reference signal for a candidate cell among the plurality of cells.

At step S1002, the network device 102 receives layer 1 reference signal receiving power of at least one candidate cell sent by the user equipment, where the layer 1 reference signal receiving power of the at least one candidate cell is not lower than a second threshold value.

At step S1003, the user equipment 101 is switched from accessing the serving cell to accessing a target candidate cell among the at least one candidate cell.

In some possible implementations, the target candidate cell is, for example, the one with the largest L1-RSRP among the at least one candidate cell.

In some possible implementations, when the cell accessed by the user equipment 101 is switched to the target candidate cell, the target candidate cell becomes a new serving cell, and the original serving cell may become a new candidate cell.

In some possible implementations, after accessing a new serving cell, that is, a target candidate cell, the user equipment 101 may perform L1-RSRP measurement of its corresponding candidate cell according to the measurement gap configuration information for the target candidate cell.

In the embodiment of the present disclosure, the network device 102 performs cell switching according to the measurement result of L1-RSRP of at least one candidate cell reported by the user equipment 101, so as to improve the communication quality of the user equipment 101 on the basis of ensuring a low switching delay.

The present disclosure provides a method of sending measurement configuration information, which is performed by the network device 102. The method includes steps S901˜S902, specifically:
at step S901, the network device 102 sends first measurement configuration information to a user equipment 101, where the first measurement configuration information includes a plurality of sets of measurement gap configuration information, and the plurality of sets of measurement gap configuration information correspond to a plurality of cells respectively, where the measurement gap configuration information includes, in a serving cell among the plurality of cells corresponding to the measurement gap configuration information, measurement gap information that the user equipment 101 performs a power measurement on a layer 1 reference signal for a candidate cell among the plurality of cells. Of course, the network device 102 may only send the measurement gap configuration information for the serving cell. Accordingly, the user equipment 101 measures layer 1 reference signal power of one or more candidate cells according to the measurement gap configuration information for the serving cell.

At step S902, the network device 102 sends a control signaling to the user equipment 101, where the control signaling includes a measurement gap identification and indication information of activating or deactivating the measurement gap configuration information.

In some possible implementations, the measurement gap configuration information includes at least one of:
a measurement gap identification;
a measurement gap duration;
a measurement gap repetition period; or
a measurement gap initial offset value.

In some possible implementations, the control signaling indicates that measurement gap configuration information corresponding to a measurement gap set with an identification is turned on or off.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 dynamically indicates, via the control signaling, that the measurement gap configuration information is turned on or off so that the user equipment 101 can perform the measurement of the candidate cell using reasonable measurement gap configuration information.

The present disclosure provides a method of sending measurement configuration information, which is performed by the network device 102. Referring to FIG. 11, FIG. 11 is a method of sending configuration information according to an embodiment of the present disclosure. As shown in FIG. 11, the method includes step S1101˜S1102, specifically:

At step S1101, the network device 102 sends second measurement configuration information to the user equipment 101.

At step S1102, the network device 102 receives an SFTD measurement report sent by the user equipment 101, where the SFTD measurement report includes an SFTD between a serving cell and at least one candidate cell.

In the embodiment of the present disclosure, the user equipment 101 performs an SFTD measurement according to the second measurement configuration information configured by the network device 102, and reports an SFTD measurement report to the network device 102, so that the network device 102 can more accurately and reasonably configure the corresponding measurement gap configuration information.

The present disclosure provides a method of sending measurement configuration information, which is performed by the network device 102. The method includes steps S1101˜S1102, where the second measurement configuration information includes:

indication information that the user equipment is required to perform an SFTD measurement, and indication information of at least one candidate cell to be performed the SFTD measurement.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 configures the second measurement configuration information for the user equipment 101, so that the user equipment 101 can know whether it is necessary to perform SFTD measurement and the candidate cell corresponding to the SFTD measurement according to the second measurement configuration information.

The present disclosure provides a method of sending measurement configuration information, which is performed by the network device 102. The method includes steps S1101˜S1106, specifically:
at step S1101, the network device 102 sends second measurement configuration information to the user equipment 101.

At step S1102, the network device 102 receives an SFTD measurement report sent by the user equipment 101, where the SFTD measurement report includes an SFTD between a serving cell and at least one candidate cell.

At step S1103, the network device 102 determines measurement gap configuration information for the serving cell according to the SFTD between the serving cell and at least one candidate cell.

At step S1104, the network device 102 sends first measurement configuration information to the user equipment 101, where the first measurement configuration information includes a plurality of sets of measurement gap configuration information, and the plurality of sets of measurement gap configuration information correspond to a plurality of cells respectively, where the measurement gap configuration information includes, in a serving cell among the plurality of cells corresponding to the measurement gap configuration information, measurement gap information that the user equipment 101 performs a power measurement on a layer 1 reference signal for a candidate cell among the plurality of cells. Of course, the network device 102 may only send the measurement gap configuration information for the serving cell. Accordingly, the user equipment 101 measures layer 1 reference signal power of one or more candidate cells according to the measurement gap configuration information for the serving cell.

At step S1105, the network device 102 receives layer 1 reference signal receiving power of at least one candidate cell sent by the user equipment, where the layer 1 reference signal receiving power of the at least one candidate cell is not lower than a second threshold value.

At step S1106, the user equipment is switched from accessing the serving cell to accessing a target candidate cell among the at least one candidate cell.

In some possible implementations, after accessing a new serving cell, that is, a target candidate cell, the user equipment 101 may re-perform an SFTD measurement between the new serving cell and a candidate cell corresponding to the target candidate cell according to the second measurement configuration information, and report the SFTD measurement report to the network device 102.

In some possible implementations, the network device 102 configures or reconfigures an initial offset value of a measurement gap corresponding to the target candidate cell according to the SFTD measurement report at this time, thereby configuring or reconfiguring the measurement gap information for the target candidate cell.

In an example, an initial offset value in the new measurement gap corresponding to the target candidate cell can be determined according to an initial offset value in the original measurement gap of the target candidate cell as a reference time, and combined with the corresponding SFTD value.

In some possible implementations, the network device 102 may dynamically indicate turning on the measurement gap configuration information for the target candidate cell and turning off the measurement gap configuration information for the original serving cell through a control signaling.

In some possible implementations, the network device 102 may issue a threshold corresponding to the target candidate cell, and the user equipment 101 determines whether to turn on (start) the L1-RSRP measurement for the current candidate cell according to a measured L1-RSRP of the target candidate cell.

In some possible implementations, the user equipment 101 performs L1-RSRP measurement of the current candidate cell according to the measurement gap configuration information for the target candidate cell.

Further, the network device 102 may also instruct the user equipment 101 which candidate cells to perform L1-RSRP measurement or report the measurement. Or, the user equipment 101 determines which candidate cells to perform L1-RSRP measurement or report the measurement according to a communication protocol.

In the embodiment of the present disclosure, the network device 102 configures the second measurement configuration information for the user equipment, the user equipment 101 performs an SFTD measurement according to the second measurement configuration information configured by the network device 102, and reports an SFTD measurement report to the network device 102, so that the network device 102 can more accurately and reasonably configure the corresponding measurement gap configuration information.

It should be noted that the aforementioned multiple embodiments executed by the network device 102 can be executed alone or in any combination, and the embodiment of the present disclosure is not limited to this.

In order to facilitate the understanding of the implementation in the embodiment of the present disclosure, a specific example is listed below for explanation.

As shown in FIG. 12, the network device 102 includes a plurality of Transmission and Reception Point (TRPs), such as TRPA, TRPB and TRPC. A first cell “cell1” currently accessed by the user equipment 101 is the serving cell, and candidate cells at this time include a second cell “cell2” and a third cell “cell3”.

The user equipment 101 measures an SFTD between cell1, cell2 and cell3 according to second measurement configuration information, and sends an SFTD measurement report to the network device 102. According to the SFTD measurement report, the network device 102 determines measurement gap configuration information corresponding to cell1, and determines measurement gap configuration information corresponding to cell2 and cell3 respectively. The user equipment 101 receives first measurement configuration information sent by the network device 102, and the first measurement configuration information includes measurement gap configuration information for three cells.

First, the user equipment 101 measures L1-RSRP of the cell1, and when the L1-RSRP of the cell1 is lower than a first threshold value, the user equipment 101 measures L1-RSRP of the cell2 and L1-RSRP of the cell3 according to the measurement gap configuration information for the cell1.

According to the L1-RSRP of cell2 and the L1-RSRP of cell3, a target candidate cell is determined, for example, cell2 with a largest L1-RSRP. The user equipment 101 is switched from access cell1 to access cell2. At this time, cell2 becomes a new serving cell, and new candidate cells include cell1 and cell3.

Then, after accessing cell2, the user equipment 101 can re-perform the SFTD measurement between cell2 and cell1, and cell2 and cell3 according to the second measurement configuration information, and report the SFTD measurement report to the network device 102. The network device 102 configures or reconfigures an initial offset value of a measurement gap corresponding to the cell2 according to the SFTD measurement report at this time, thereby configuring or reconfiguring the measurement gap information for the cell2.

The network device 102 may further issue a first threshold value corresponding to cell2, and the user equipment 101 determines whether to turn on the L1-RSRP measurement of cell1 and cell3 according to measured L1-RSRP of cell2. If the L1-RSRP of cell2 is lower than the first threshold value, the user equipment 101 performs L1-RSRP measurement of cell1 and cell3 according to the measurement gap configuration information for cell2.

Based on the same concept as the above method embodiment, an embodiment of the present disclosure further provides an apparatus for receiving measurement configuration information, which may have the functions of the user equipment 101 in the above method embodiments, and may be configured to perform the steps provided in the above method embodiments to be performed by the user equipment 101. These functions can be realized by hardware, or by software or hardware executing corresponding software. The hardware or software includes one or more modules corresponding to the above functions.

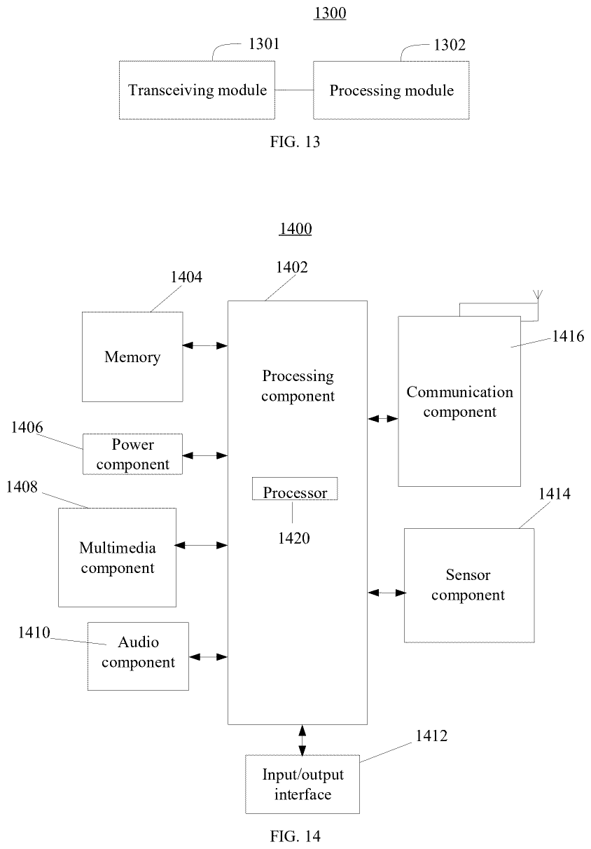

In a possible implementation, an apparatus 1300 shown in FIG. 13 can be used as the user equipment 101 involved in the above method embodiments, and perform the steps performed by the user equipment 101 in the above method embodiments. As shown in FIG. 13, the apparatus 1300 may include a transceiving module 1301 and a processing module 1302 coupled with each other, where the transceiving module may be configured to support the communication of the communication apparatus, and the processing module may be configured for the communication apparatus to perform processing operations, such as generating to-be-sent information/messages or processing received signals to obtain information/messages.

When performing the steps implemented by the user equipment 101, the transceiving module 1301 is configured to receive first measurement configuration information sent by a network device, where the first measurement configuration information at least indicates measurement gap configuration information for a serving cell. The processing module 1302 is configured to perform a power measurement on a reference signal for a candidate cell according to the measurement gap configuration information for the serving cell.

In some possible implementations, the first measurement configuration information further indicates measurement gap configuration information for at least one candidate cell.

In some possible implementations, the power measurement on the reference signal is a power measurement on a layer 1 reference signal.

In some possible implementations, the first measurement configuration information indicates a plurality of sets of measurement gap configuration information, where the plurality of sets of measurement gap configuration information correspond to a plurality of cells respectively, and the plurality of cells at least include the serving cell and at least one candidate cell.

In some possible implementations, the measurement gap configuration information indicates a measurement gap, and where during the measurement gap, the user equipment performs the power measurement on the reference signal for the candidate cell without performing service transmission with the serving cell.

In some possible implementations, the processing module 1302 is further configured to measure, in response to layer 1 reference signal receiving power of the serving cell being lower than a first threshold value, layer 1 reference signal receiving power of the candidate cell according to the measurement gap configuration information for the serving cell.

In some possible implementations, the transceiving module 1301 is further configured to receive a radio resource control signaling sent by the network device, and the radio resource control signaling includes the first threshold value.

In some possible implementations, the transceiving module 1301 is further configured to send, in response to layer 1 reference signal receiving power of at least one candidate cell not being lower than a second threshold value, the layer 1 reference signal receiving power of the at least one candidate cell to the network device.

In some possible implementations, the transceiving module 1301 is further configured to receive a control signaling sent by the network device, where the control signaling includes a measurement gap identification and indication information of activating or deactivating the measurement gap configuration information.

In some possible implementations, the processing module 1302 is further configured to perform, in response to the control information indicating activation of the measurement gap configuration information for the serving cell, a power measurement on a layer 1 reference signal for the candidate cell according to the measurement gap configuration information for the serving cell.

In some possible implementations, the control signaling is a media access control (MAC) signaling or includes downlink control information (DCI).

In some possible implementations, the processing module 1302 is further configured to measure, according to received second measurement configuration information, a system frame number and frame boundary timing difference (SFTD) between the serving cell and at least one candidate cell; and
the transceiving module 1301 is further configured to send an SFTD measurement report to the network device, where the SFTD measurement report includes the SFTD between the serving cell and at least one candidate cell, and the first measurement configuration information is determined by the network device according to the SFTD measurement report.

In some possible implementations, the second measurement configuration information includes:
indication information that the user equipment is required to perform an SFTD measurement, and indication information of at least one candidate cell to be performed the SFTD measurement.

In some possible implementations, the measurement gap configuration information includes at least one of:
a measurement gap identification;
a measurement gap duration;
a measurement gap repetition period; or
a measurement gap initial offset value.

When the apparatus for receiving configuration information is user equipment 101, its structure may also be as shown in FIG. 14. The apparatus 1400 may be a mobile phone, a computer, a digital broadcasting terminal, a messaging device, a game console, a tablet device, a medical device, a fitness device, a personal digital assistant, etc.

Referring to FIG. 14, the apparatus 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 generally controls the overall operation of the apparatus 1400, such as operations associated with display, telephone call, data communication, camera operation and recording operation. The processing component 1402 may include one or more processors 1420 to execute instructions to complete all or part of steps of the above-mentioned method. In addition, the processing component 1402 may include one or more modules to facilitate interactions between the processing component 1402 and other components. For example, the processing component 1402 may include a multimedia module to facilitate interactions between the multimedia component 1408 and the processing component 1402.

The memory 1404 is configured to store various types of data to support operations in the apparatus 1400. Examples of these data include instructions of any application program or method for being operated on the apparatus 1400, contact data, phone book data, messages, pictures, videos, etc. The memory 1404 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1406 provides power to various components of the apparatus 1400. The power component 1406 may include a power management system, one or more power supplies, and other components associated with generating, managing and distributing power for the apparatus 1400.

The multimedia component 1408 includes a screen that provides an output interface between the apparatus 1400 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 1408 includes a front camera and/or a rear camera. When the apparatus 1400 is in an operation mode, such as a shooting mode or a video mode, the front camera and/or the rear camera can receive external multimedia data. Each front camera and rear camera may be a fixed optical lens system or have focal length and optical zoom capability.

The audio component 1410 is configured to output and/or input audio signals. For example, the audio component 1410 includes a microphone (MIC) configured to receive external audio signals when the apparatus 1000 is in the operation mode, such as a calling mode, a recording mode and a voice recognition mode. The received audio signal may be further stored in the memory 1404 or transmitted via the communication component 1416. In some embodiments, the audio component 1410 further includes a speaker for outputting audio signals.

The I/O interface 1412 provides an interface between the processing component 1402 and peripheral interface modules, where the peripheral interface modules may be keyboards, click-wheels, buttons, etc. These buttons may include, but are not limited to: home button, volume button, start button and lock button.

The sensor component 1414 includes one or more sensors for providing various aspects of state evaluation for the apparatus 1400. For example, the sensor component 1414 can detect an on/off state of the apparatus 1400, a relative positioning of components, for example, the components are the display and the keypad of the apparatus 1400, and the sensor component 1414 can also detect a position change of the apparatus 1400 or a component of the apparatus 1400, presence or absence of user contact with the apparatus 1400, orientation or acceleration/deceleration of the apparatus 1400 and a temperature change of the apparatus 1400. The sensor component 1414 may include a proximity sensor configured to detect presence of a nearby object without any physical contact. The sensor component 1414 may also include an optical sensor, such as a CMOS or CCD image sensor, for use in imaging applications. In some embodiments, the sensor component 1414 may further include an acceleration sensor, a gyroscope sensor, a magnetic sensor, a pressure sensor or a temperature sensor.

The communication component 1416 is configured to facilitate wired or wireless communication between the apparatus 1400 and other devices. The apparatus 1400 can access a wireless network based on communication standards, such as WiFi, 2G or 3G, or combinations thereof. In an embodiment of the present disclosure, the communication component 1416 receives a broadcast signal or broadcast related information from an external broadcast management system via a broadcast channel. In an embodiment of the present disclosure, the communication component 1416 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 1400 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 1404 including instructions, where the instructions can be executed by a processor 1420 of the apparatus 1400 to complete the above-mentioned method. For example, the non-transitory computer-readable storage medium may be an ROM, a random access memory (RAM), a CD-ROM, a magnetic tape, a floppy disk, an optical data storage device, etc.

Based on the same concept as the above method embodiment, an embodiment of the present disclosure further provides an apparatus for sending measurement configuration information, which may have the functions of the network device 102 in the above method embodiments, and may be configured to perform the steps provided in the above method embodiments to be performed by the network device 102. These functions can be realized by hardware, or by software or hardware executing corresponding software. The hardware or software includes one or more modules corresponding to the above functions.

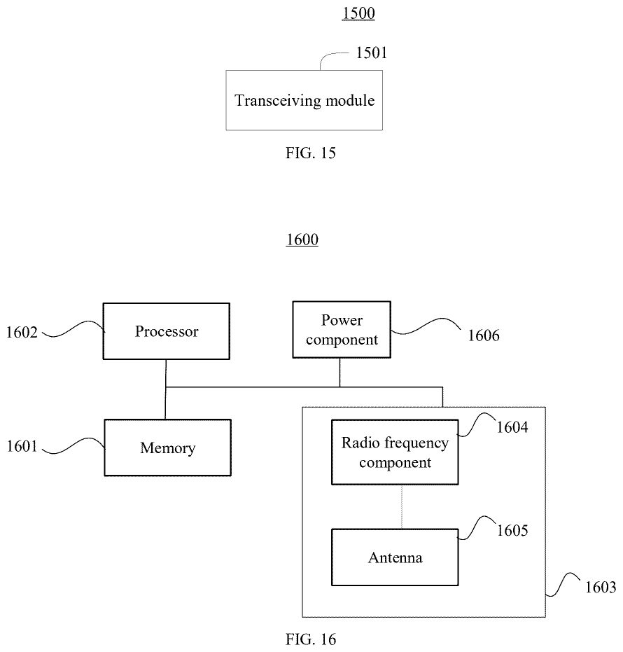

In a possible implementation, the communication apparatus 1500 shown in FIG. 15 can be used as the network device 102 involved in the above method embodiments, and perform the steps performed by the network device 102 in the above method embodiments. As shown in FIG. 15, the communication apparatus 1500 may include a transceiving module 1501, which may be configured to support the communication apparatus 1500 for communication, and the transceiving module 1501 may have wireless communication capabilities, such as being able to communicate wirelessly with other communication apparatuses via a wireless air interface.

When performing the steps implemented by the network device 102, the transceiving module 1501 is configured to send first measurement configuration information to a user equipment, where the first measurement configuration information at least indicates measurement gap configuration information for a serving cell, and where the measurement gap configuration information indicates measurement gap information configured for the user equipment to perform a power measurement on a reference signal for a candidate cell, and the measurement gap information is for the serving cell.

In some possible implementations, the transceiving module 1501 is further configured to receive layer 1 reference signal receiving power of at least one candidate cell sent by the user equipment, where the layer 1 reference signal receiving power of the at least one candidate cell is not lower than a second threshold value.

The communication apparatus 1500 further includes a processing module configured to switch the user equipment from accessing the serving cell to accessing a target candidate cell among the at least one candidate cell.

In some possible implementations, the transceiving module 1501 is further configured to send a control signaling to the user equipment, where the control signaling includes a measurement gap identification and indication information of activating or deactivating the measurement gap configuration information.

In some possible implementations, the transceiving module 1501 is further configured to send second measurement configuration information to the user equipment and receive a system frame number and frame boundary timing difference (SFTD) measurement report sent by the user equipment, where the SFTD measurement report includes an SFTD between the serving cell and at least one candidate cell.

In some possible implementations, the second measurement configuration information includes:
indication information that the user equipment is required to perform an SFTD measurement, and indication information of at least one candidate cell to be performed the SFTD measurement.

In some possible implementations, the communication apparatus 1500 is further configured to:
determine the measurement gap configuration information for the serving cell according to the SFTD between the serving cell and at least one candidate cell.

When the communication apparatus is a network device 102, the structure can further be as shown in FIG. 16. The structure of the communication apparatus will be described by taking a base station an example. As shown in FIG. 16, the communication apparatus 1600 includes a memory 1601, a processor 1602, a transceiver component 1603, and a power component 1606. The memory 1601 is coupled with the processor 1602 and can be configured to store programs and data necessary for the communication apparatus 1600 to implement various functions. The processor 1602 is configured to support the communication apparatus 1600 to perform the corresponding function in the above method, which can be realized by calling the programs stored in the memory 1601. The transceiver component 1603 can be a wireless transceiver, which can be configured to support the communication apparatus 1600 to receive signaling and/or data and send signaling and/or data through a wireless air interface. The transceiver component 1603 can also be named as a transceiver unit or a communication unit. The transceiver component 1603 can include a radio frequency component 1604 and one or more antennas 1605, where the radio frequency component 1604 can be a remote radio unit (RRU), which can be used for the transmission of radio frequency signals and the conversion between radio frequency signals and baseband signals, and the one or more antennas 1605 can be used for the radiation and reception of radio frequency signals.

When the communication apparatus 1600 needs to transmit data, the processor 1602 can perform baseband processing on the to-be-transmitted data, and then output a baseband signal to a radio frequency unit, and the radio frequency unit performs radio frequency processing on the baseband signal and then transmits the radio frequency signal in the form of electromagnetic waves through the antenna. When data is sent to the communication apparatus 1600, the radio frequency unit receives the radio frequency signal through the antenna, converts the radio frequency signal into a baseband signal, and outputs the baseband signal to the processor 1602, which converts the baseband signal into data and processes the data.

Other implementations of the embodiments of the present disclosure will easily occur to those skilled in the art after considering the specification and practicing the present disclosure disclosed herein. The present disclosure is intended to cover any variations, uses or adaptations of the embodiments of the present disclosure, and these variations, uses or adaptations follow general principles of the embodiments of the present disclosure and include common sense or common technical means in the technical field that are not disclosed in the present disclosure. The specification and embodiments are to be regarded as examples only, and true scope and spirit of the embodiments of the present disclosure are indicated by the following claims.

It should be understood that the embodiments of the present disclosure are not limited to precise structures described above and shown in the accompanying drawings, and various modifications and changes can be made without departing from its scope. The scope of the embodiments of the present disclosure is limited only by the appended claims.

### INDUSTRIAL APPLICABILITY

In the methods of the present disclosure, a network device indicates measurement gap configuration information for a serving cell by sending first measurement configuration information to a user equipment. The user equipment can determine the measurement gap configuration information for the serving cell, and perform a power measurement on a reference signal for a candidate cell according to the measurement gap configuration information for the serving cell. Therefore, the network device can configure the user equipment with reasonable measurement gap configuration information, so that the user equipment can realize effective neighbor cell measurement.

1. A method for receiving measurement configuration information, performed by a user equipment and comprising:
receiving first measurement configuration information sent by a network device, wherein the first measurement configuration information at least indicates measurement gap configuration information for a serving cell; and
performing a power measurement on a reference signal for a candidate cell according to the measurement gap configuration information for the serving cell.

2. The method according to claim 1, wherein the first measurement configuration information further indicates measurement gap configuration information for at least one candidate cell.

3. The method according to claim 1, wherein the reference signal is a layer 1 reference signal.

4. The method according to claim 1, wherein the first measurement configuration information indicates a plurality of sets of measurement gap configuration information,
wherein the plurality of sets of measurement gap configuration information correspond to a plurality of cells respectively, and the plurality of cells at least comprise the serving cell and at least one candidate cell.

5. The method according to claim 1, wherein the measurement gap configuration information indicates a measurement gap, and
wherein, during the measurement gap, the user equipment performs the power measurement on the reference signal for the candidate cell without performing service transmission with the serving cell.

6. The method according to claim 3, wherein, the performing the power measurement on the reference signal for a candidate cell according to the measurement gap configuration information for the serving cell comprises:
measuring, in response to layer 1 reference signal receiving power of the serving cell being lower than a first threshold value, layer 1 reference signal receiving power of the candidate cell according to the measurement gap configuration information for the serving cell.

7. The method according to claim 6, further comprising:
receiving a radio resource control signaling from the network device, wherein the radio resource control signaling comprises the first threshold value.

8. The method according to claim 6, further comprising:
sending, in response to the layer 1 reference signal receiving power of the candidate cell not being lower than a second threshold value, the layer 1 reference signal receiving power of the candidate cell to the network device.

9. The method according to claim 1, wherein the performing the power measurement on the reference signal for a candidate cell according to the measurement gap configuration information for the serving cell comprises:
receiving a control signaling sent by the network device, wherein the control signaling comprises a measurement gap identification and indication information of activating or deactivating the measurement gap configuration information, wherein the control signaling is a media access control (MAC) signaling or comprises downlink control information (DCI);
performing, in response to the control signaling indicating activation of the measurement gap configuration information for the serving cell, a power measurement on a layer 1 reference signal for the candidate cell according to the measurement gap configuration information for the serving cell.

10-11. (canceled)

12. The method according to claim 1, further comprising:
measuring, according to received second measurement configuration information, a system frame number and frame boundary timing difference (SFTD) between the serving cell and at least one candidate cell; and
sending an SFTD measurement report to the network device, wherein the SFTD measurement report comprises the SFTD between the serving cell and at least one candidate cell, and the first measurement configuration information is determined by the network device according to the SFTD measurement report.

13. The method according to claim 12, wherein the second measurement configuration information comprises:
indication information that the user equipment is required to perform an SFTD measurement, and
indication information of at least one candidate cell to be performed the SFTD measurement.

14. The method according to claim 1, wherein the measurement gap configuration information comprises at least one of:
a measurement gap identification;
a measurement gap duration;
a measurement gap repetition period; or
a measurement gap initial offset value.

15. A method for sending measurement configuration information, performed by a network device and comprising:
sending first measurement configuration information to a user equipment,
wherein the first measurement configuration information at least indicates measurement gap configuration information for a serving cell, and
wherein the measurement gap configuration information indicates measurement gap information configured for the user equipment to perform a power measurement on a reference signal for a candidate cell, and the measurement gap information is for the serving cell.

16. The method according to claim 15, further comprising:
receiving layer 1 reference signal receiving power of at least one candidate cell sent by the user equipment, wherein the layer 1 reference signal receiving power of the at least one candidate cell is not lower than a second threshold value; and
switching the user equipment from accessing the serving cell to accessing a target candidate cell among the at least one candidate cell.

17. The method according to claim 15, further comprising:
sending a control signaling to the user equipment, wherein the control signaling comprises a measurement gap identification and indication information of activating or deactivating the measurement gap configuration information.

18. The method according to claim 15, further comprising:
sending second measurement configuration information to the user equipment; and
receiving a system frame number and frame boundary timing difference (SFTD) measurement report sent by the user equipment, wherein the SFTD measurement report comprises an SFTD between the serving cell and at least one candidate cell.

19. The method according to claim 18, wherein the second measurement configuration information comprises:
indication information that the user equipment is required to perform an SFTD measurement, and
indication information of at least one candidate cell to be performed the SFTD measurement.

20. The method according to claim 18, further comprising:
determining the measurement gap configuration information for the serving cell according to the SFTD between the serving cell and at least one candidate cell.

21-22. (canceled)

23. A communication apparatus comprising:
a memory that stores a computer program;
one or more processors that are communicatively coupled to the memory,
wherein the
computer program when collectively executed by the one or more processors cause the communication apparatus to:
receive first measurement configuration information sent by a network device, wherein the first measurement configuration information at least indicates measurement gap configuration information for a serving cell; and perform a power measurement on a reference signal for a candidate cell according to the measurement gap configuration information for the serving cell.

24. A communication apparatus comprising:
a memory that stores a computer program,
one or more processors that are communicatively coupled to the memory, wherein the computer program when collectively executed by the processors cause the communication apparatus to act as the network device and perform,
the method according to claim 15.

25-26. (canceled)
